(19) United States
(12) Patent Application Publication
(10) Pub. No.: US 2025/0182031 A1
(43) Pub. Date: Jun. 5, 2025

(54) METHOD, APPARATUS AND TERMINAL DEVICE FOR PROCESSING PERFORMANCE INDICATORS

(71) Applicants: Lemon Inc., Grand Cayman (KY); Beijing Zitiao Network Technology Co., Ltd., Beijing (CN)

(72) Inventors: Siming Zhao, Los Angeles, CA (US); Houtong Zhang, Beijing (CN)

(21) Appl. No.: 18/793,750

(22) Filed: Aug. 3, 2024

(30) Foreign Application Priority Data
Dec. 1, 2023 (CN) 202311629004.1

(51) Int. Cl. G06Q 10/0639

(52) U.S. Cl. CPC G06Q 10/06393

(57) ABSTRACT

The disclosure provides a method, apparatus and terminal device for processing performance indicators. The method includes: acquiring historical business data comprising a value of a business indicator of an application program when a plurality of performance indicators have different values; determining, according to the historical business data, a plurality of target performance indicators in the plurality of performance indicators and determining a regression coefficient of each target performance indicator, the regression coefficient being used for indicating an influence degree of the target performance indicator on the business indicator; and determining, according to the regression coefficient of each target performance indicator and a minimum difference value of a significant change of the business indicator, a maximum acceptable deterioration value corresponding to each target performance indicator. The alarm accuracy of target performance indicators is improved.

### CROSS REFERENCE

This application is filed based on a Chinese patent application with application No. 202311629004.1, filed on Dec. 1, 2023, entitled “METHOD, APPARATUS AND TERMINAL DEVICE FOR PROCESSING PERFORMANCE INDICATORS”, and claims the benefit of the Chinese patent application, the entirety of which is incorporated herein by reference.

### FIELD

Embodiments of the present disclosure relate to the field of data processing technologies, in particular to a method, apparatus and terminal device for processing performance indicators.

### BACKGROUND

Performance indicators of an application program can affect business indicators of the application program. For example, a video playback definition (performance indicator) of the application program can affect the number of daily active users (business indicator) of the application program.

At present, when any performance indicator is adjusted, multiple performance indicators may affect each other. Therefore, in order to avoid the too large influence of a change of the performance indicators on the business indicators, a maximum adjustable value of each performance indicator may be set based on manual experience, and then the value is determined as an alarm threshold. After the change of the performance indicator exceeds the maximum adjustable value, the terminal device may give an alarm. However, the accuracy of the maximum adjustable value determined based on manual experience is lower, leading to a lower alarm accuracy of the performance indicators.

### SUMMARY

The present disclosure provides a method, apparatus and terminal device for processing performance indicators, which are used to solve the technical problem of low alarm accuracy of performance indicators in the existing art.

In a first aspect, the present disclosure provides a method of processing performance indicators, comprising:
acquiring historical business data comprising a value of a business indicator of an application program when a plurality of performance indicators have different values;
determining, according to the historical business data, a plurality of target performance indicators in the plurality of performance indicators and determining a regression coefficient of each target performance indicator, the regression coefficient being used for indicating an influence degree of the target performance indicator on the business indicator; and
determining, according to the regression coefficient of each target performance indicator and a minimum difference value of a significant change of the business indicator, a maximum acceptable deterioration value corresponding to each target performance indicator.

In a second aspect, the present disclosure provides an apparatus for processing performance indicators, comprising an acquisition module, a first determination module and a second determination module, wherein:
the acquisition module is configured for acquiring historical business data comprising a value of a business indicator of an application program when a plurality of performance indicators have different values;
the first determination module is configured for determining, according to the historical business data, a plurality of target performance indicators in the plurality of performance indicators and determining a regression coefficient of each target performance indicator, the regression coefficient being used for indicating an influence degree of the target performance indicator on the business indicator; and
the second determination module is configured for determining, according to the regression coefficient of each target performance indicator and a minimum difference value of a significant change of the business indicator, a maximum acceptable deterioration value corresponding to each target performance indicator.

In a third aspect, the embodiments of the present disclosure provide a terminal device comprising: a processor and a memory;
the memory stores computer-executable instructions; and
the processor executes the computer-executable instructions stored in the memory, so that the processor performs a method of processing performance indicators according to the above first aspect or that may be involved in the first aspect.

In a fourth aspect, the embodiments of the present disclosure provide a computer-readable storage medium. Computer-executable instructions are stored in the computer-readable storage medium, and a processor, when executing the computer-executable instructions, implements a method of processing performance indicators according to the above first aspect or that may be involved in the first aspect.

### BRIEF DESCRIPTION OF THE SEVERAL VIEWS OF THE DRAWINGS

To describe the technical solutions in the embodiments of the present disclosure or the prior art more clearly, the following briefly introduces the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of an application scenario according to an embodiment of the present disclosure;

FIG. 2 is a schematic flowchart of a method of processing performance indicators according to an embodiment of the present disclosure;

FIG. 3 is a schematic diagram of influence degree curves according to an embodiment of the present disclosure;

FIG. 4 is a schematic diagram of a process of determining target performance indicators according to an embodiment of the present disclosure;

FIG. 5 is a schematic diagram of a method of determining an exchange relationship according to an embodiment of the present disclosure;

FIG. 6 is a schematic diagram of an optimization process of a reference performance indicator according to an embodiment of the present disclosure;

FIG. 7 is a schematic structural diagram of an apparatus for processing performance indicators according to an embodiment of the present disclosure;

FIG. 8 is a schematic structural diagram of another apparatus for processing performance indicators according to an embodiment of the present disclosure; and

FIG. 9 is a schematic structural diagram of a terminal device according to an embodiment of the present disclosure.

### DETAILED DESCRIPTION

Exemplary embodiments will be explained in detail here, and examples thereof are illustrated in the accompanying drawings. When the following descriptions involve the accompanying drawings, unless otherwise indicated, the same numbers in different accompanying drawings represent the same or similar elements. The embodiments described in the following exemplary embodiments do not represent all embodiments consistent with the present disclosure. Instead, they are merely examples of apparatuses and methods consistent with some aspects of the present disclosure as detailed in the appended claims.

In order to facilitate understanding, the concepts involved in the embodiments of the present disclosure are described below.

The terminal device is a type of device with a wireless transceiver function. The terminal device may be deployed on land in an indoor or outdoor, handheld, wearable or vehicle-mounted manner. The terminal device may be a mobile phone, a tablet computer (Pad), a computer with a wireless transceiver function, a virtual reality (VR) terminal device, an augmented reality (AR) terminal device, a wireless terminal in industrial control, a vehicle-mounted terminal device, a wireless terminal in self driving, a wireless terminal device in remote medical, a wireless terminal device in a smart grid, a wireless terminal device in transportation safety, a wireless terminal device in smart city, a wireless terminal device in smart home, a wearable terminal device, etc. The terminal device involved in the embodiments of the present disclosure may also be called a terminal, user equipment (UE), an access terminal device, a vehicle-mounted terminal, an industrial control terminal, a UE unit, a UE station, a mobile station, a mobile pad, a remote station, a remote terminal device, a mobile device, a UE terminal device, a wireless communication device, a UE agent or UE apparatus, etc. The terminal device may also be fixed or mobile.

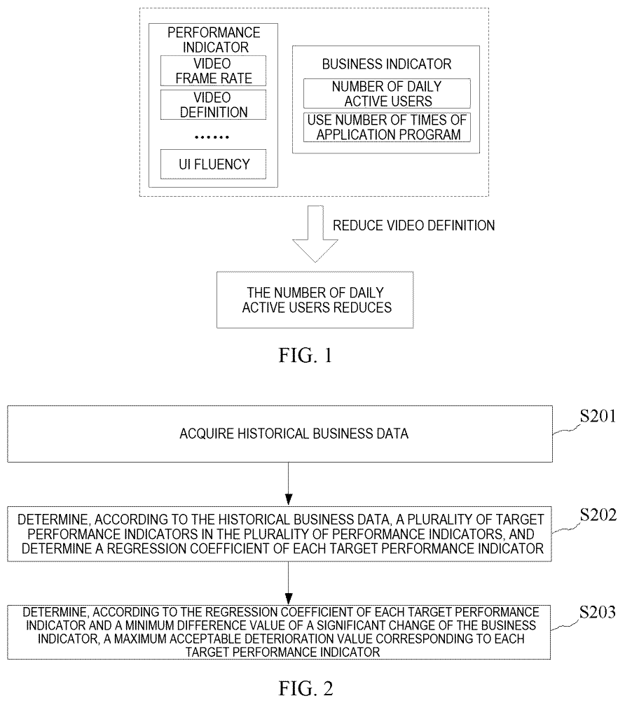

Next, in combination with FIG. 1, an application scenario of the embodiment of the present disclosure will be described.

FIG. 1 is a schematic diagram of an application scenario according to the embodiment of the present disclosure. Please refer to FIG. 1, performance indicators and business indicators of an application program are included, wherein the performance indicators of the application program may include a video frame rate, a video definition, . . . , a UI fluency, etc., and the business indicators of the application program may include the number of daily active users and the use number of times of the application program, etc. If the terminal device reduces the video definition of the application program, a reduction in the number of daily active users in the business indicators will be caused.

It should be noted that FIG. 1 is only an exemplary illustration of relationships between the business indicators and the performance indicators, and is not a limitation to the application scenario of the embodiment of the present disclosure.

In the related art, the performance indicators of the application program may affect the business indicators of the application program. There are a variety of performance indicators, and the multiple performance indicators may affect each other (for example, an increase of performance indicator A will lead to a decrease of performance indicator B). Therefore, in order to avoid the too large influence of a change of the performance indicator on the business indicator, it is necessary to set a maximum adjustable value (alarm threshold) for each performance indicator, and when the change value of the performance indicator exceeds the alarm threshold, the terminal device may give an alarm to the performance indicator. At present, the alarm threshold corresponding to each performance indicator may be determined based on manual experience, but the alarm threshold of the performance indicator determined by manual experience is lower in accuracy, leading to lower alarm accuracy of the performance indicator.

In order to solve the technical problems in the related art, the embodiments of the present disclosure provide a method of processing performance indicators. The terminal device can acquire historical business data, wherein the historical business data can include a value of the business indicator of an application program when multiple performance indicators have different values, and the terminal device can determine multiple performance indicators to be selected in the multiple performance indicators according to the historical business data, and process the multiple performance indicators to be selected by a multiple linear regression method to acquire a P value of each performance indicator to be selected, wherein the P value can be used for indicating whether there is significant difference between a regression coefficient of the performance indicator to be selected and a preset value (which may be 0), and the performance indicator to be selected of which the P value is less than or equal to the preset threshold is determined as the target performance indicator. The terminal device can determine a maximum acceptable deterioration value corresponding to each target performance indicator according to the regression coefficient of each target performance indicator and a minimum difference value of a significant change of the business indicator. In the above method, since the regression coefficient of the target performance indicator can represent an influence degree of the target performance indicator on the business indicator, when the target performance indicator has a greater influence on the business indicator, the terminal device can accurately determine the maximum acceptable deterioration value corresponding to the target performance indicator within the range of the minimum difference value of the significant change of the business indicator based on the regression coefficient of the target performance indicator, thereby improving the accuracy of the maximum acceptable deterioration value and the alarm accuracy of the target performance indicator.

The technical solution of the present disclosure and how the technical solution of the present disclosure solves the above technical problems will be described in detail with specific embodiments. The following several specific embodiments may be combined with each other, and the same or similar concepts or processes are possibly not repeated in some embodiments. The embodiments of the present disclosure will be described below in combination with the accompanying drawings.

FIG. 2 is a flowchart of a method of processing performance indicators according to an embodiment of the present disclosure. Referring to FIG. 2, the method may include following steps.

S201: historical business data is acquired.

An execution subject of the embodiment of the present disclosure may be a terminal device or an apparatus for processing performance indicators disposed in the terminal device, which is not limited by the embodiment of the present disclosure. The apparatus for processing performance indicators may be software or a combination of software and hardware, which is not limited by the embodiment of the present disclosure.

The historical business data may include a value of a business indicator of an application program when multiple performance indicators have different values. For example, the application program may be a program to be updated. After the application program is developed, developers may update multiple performances in the application program. In the updating process, it is necessary to determine the values of the performance indicators of the application program, and then positively promote the business indicator of the application program.

Optionally, the performance indicators are used for indicating the performances of the application program. For example, the performance indicators may include client side performance indicators, playback performance indicators and production side performance indicators. For example, the client side performance indicators may include a fluency of a user interface (UI), dynamic resources (power consumption, etc.) and static resources (storage space, etc.) in the application program, which is not limited by the embodiment of the present disclosure. For example, the playback performance indicators may include a video playback frame rate, a video playback definition, etc., which is not limited by the embodiment of the present disclosure. For example, the production side performance indicators may include the number of affairs processed in unit time, the number of queries responded per second, etc., which is not limited by the embodiment of the present disclosure.

Optionally, the business indicator is used for indicating the performances of the application program on a business side. For example, the business indicator may include the number of daily active users of the application program, and the business indicator may also include the number of times of the user using the application program in a historical period, etc., which is not limited by the embodiment of the present disclosure.

Optionally, when the performance indicators have different values, the business indicator also has corresponding values. For example, if the performance indicators are: video definition 1, video playback frame rate 2 and UI fluency 3, then the business indicator corresponding to the performance indicators may be: the number of daily active users is 10000; and if the performance indicators are: video definition A, video playback frame rate B and UI fluency C, then the business indicator corresponding to the performance indicators may be: the number of daily active users is 20000.

It should be noted that when multiple performance indicators have different values, the value of the business indicator may be the same or different, which is not limited by the embodiment of the present disclosure, and the historical business data may include corresponding relationships between multiple groups of performance indicators and the business indicator. For example, the historical business data may include the corresponding relationships between performance indicator 1 and performance indicator 2 and the business indicator, and may also include the corresponding relationships between performance indicator 2 and performance indicator 3 and the business indicator. In addition, the historical business data may include the corresponding relationships between value A of performance indicator 1 and value B of performance indicator 2 and the value of the business indicator, and the historical business data may also include the corresponding relationships between value C of performance indicator 1 and value D of performance indicator 2 and the value of the business indicator, which is not limited by the embodiment of the present disclosure.

Optionally, the terminal device may acquire the historical business data in a database. For example, the database may store the corresponding relationships between the performance indicators and the business indicator, and the terminal device may acquire the historical business data in the database.

It should be noted that the terminal device may also acquire the historical business data based on any feasible implementation, which is not limited by the embodiment of the present disclosure. Moreover, user information (including but not limited to user equipment information, user personal information, etc.) and data (including but not limited to data for analysis, stored data, displayed data, etc.) involved in the embodiment of the present disclosure are all information and data authorized by the user or fully authorized by all parties; the collecting, using, and processing of relevant data must comply with relevant laws, regulations, and standards; and corresponding operation entries are provided for the user to choose authorization or rejection.

S202: according to historical business data, multiple target performance indicators are determined in multiple performance indicators, and a regression coefficient of each target performance indicator is determined.

Optionally, the target performance indicators may be performance indicators that affect the business indicator. For example, in an actual application process, the application program may include multiple performance indicators, and the values of part of performance indicators will have a positive or negative influence on the value of the business indicator, and the part of performance indicators may be the target performance indicators. For example, if when performance indicator 1 increases, the value of the business indicator will increase, when performance indicator 2 decreases, the value of the business indicator will increase, and when performance indicator 3 increases, the value of the business indicator remains unchanged, then the terminal device may determine that the target performance indicators may include performance indicator 1 and performance indicator 2.

The regression coefficient may be used for indicating an influence degree of the target performance indicator on the business indicator. For example, the greater the regression coefficient, the greater the influence degree of the target performance indicator on the business indicator, and the smaller the regression coefficient, the smaller the influence degree of the target performance indicator on the business indicator. For example, if the regression coefficient of target performance indicator 1 is 0.05 and the regression coefficient of target performance indicator 2 is 0.1, then the terminal device may determine that the influence degree of target performance indicator 1 on the business indicator is greater than that of target performance indicator 2 on the business indicator.

Optionally, based on the following feasible implementation, the terminal device may determine multiple target performance indicators in multiple performance indicators according to the historical business data: multiple performance indicators to be selected are determined in the multiple performance indicators according to the historical business data, the multiple performance indicators to be selected are processed by a multiple linear regression method to acquire P value of each performance indicator to be selected, and the performance indicators to be selected of which the P value is less than or equal to a preset threshold are determined as the target performance indicators.

There is no problem of multicollinearity in the multiple performance indicators to be selected. For example, when linear regression is performed, if a relevancy between two performance indicators is higher, it will lead to the problem of multicollinearity. When there is no problem of multicollinearity between multiple performance indicators to be selected, it means that the relevancies between multiple performance indicators to be selected are lower.

Optionally, after the terminal device acquires the multiple performance indicators to be selected, a variance inflation factor (VIF) of the multiple performance indicators to be selected may be further determined, and whether there is the problem of multicollinearity between the multiple performance indicators to be selected is further determined. For example, the VIF may indicate the severity of multicollinearity in a multiple linear regression model. If the VIF value of the multiple performance indicators to be selected is lower, it means that there is no problem of multicollinearity between the multiple performance indicators to be selected. If the VIF value of the multiple performance indicators to be selected is higher, it means that there is still the problem of multicollinearity between the multiple performance indicators to be selected. In this way, the problem of multicollinearity can be effectively avoided and the accuracy of determining the target performance indicators is improved.

The P value is used for indicating whether there is a significant difference between the regression coefficient of the performance indicator to be selected and the preset value. For example, the terminal device may take multiple performance indicators to be selected as input variables, and perform linear regression processing on the multiple performance indicators to be selected for acquiring the regression coefficient of each performance indicator to be selected and the P value of each performance indicator to be selected. If the P value is smaller, it means that there is a significant difference between the regression coefficient of the performance indicator to be selected and the preset value, that is, the performance indicator to be selected has a greater influence on the business indicator; and if the P value is larger, it means that that there is no significant difference between the regression coefficient of the performance indicator to be selected and the preset value, that is, the performance indicator to be selected has a smaller influence on the business indicator.

It should be noted that the electronic device may determine the regression coefficient and P value of the performance indicator to be selected based on any feasible method, which is not limited by the embodiment of the present disclosure.

Optionally, determining, by the terminal device, the multiple performance indicators to be selected in the multiple performance indicators according to the historical business data may specifically include: processing the historical business data by a lasso linear regression method to acquire an influence degree curve of each performance indicator on the business indicator, sorting the multiple performance indicators according to multiple influence degree curves in an order that the influence degree becomes a preset value, and determining the first N performance indicators in the multiple sorted performance indicators as multiple initial performance indicators, wherein N is an integer greater than 1; and determining the multiple performance indicators to be selected in the multiple initial performance indicators according to relevancies between the multiple initial performance indicators. In this way, the relevancies between the multiple performance indicators to be selected and the business indicator are higher, thereby improving the accuracy of the target performance indicators and the alarm accuracy of the target performance indicators.

Optionally, the influence degree may be the regression coefficient of the performance indicator. For example, in an actual application process, when multiple performance indicators in the historical business data are processed by the lasso linear regression method, the terminal device may continuously increase a penalty function, and then may continuously compress the regression coefficient of the performance indicator. For example, as a penalty term increases, the performance indicator of which the regression coefficient becomes 0 earlier is less important, and the performance indicator of which the regression coefficient becomes 0 later is more important. In addition, the terminal device may sort the importance of multiple performance indicators based on the order of regression coefficients becoming 0.

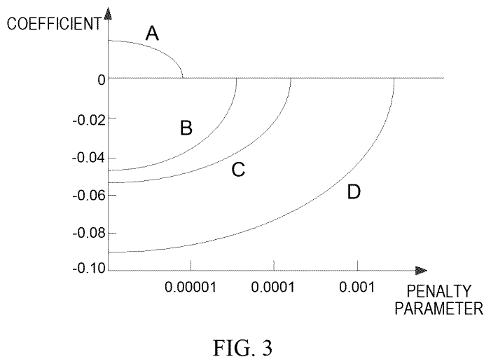

Next, in combination with FIG. 3, the influence degree curves of the performance indicators on the business indicator will be explained.

FIG. 3 is a schematic diagram of the influence degree curves according to an embodiment of the present disclosure. Please refer to FIG. 3, a coordinate system is included. A vertical axis of the coordinate system may be the coefficients of the performance indicators, and a horizontal axis of the coordinate system may be penalty parameters. The coordinate system may include curve A, curve B, curve C and curve D, wherein each curve corresponds to one performance indicator. For example, curve A may indicate the relationship between the coefficient of performance indicator 1 and the penalty parameters, curve B may indicate the relationship between the coefficient of performance indicator 2 and the penalty parameters, curve C may indicate the relationship between the coefficient of performance indicator 3 and the penalty parameters, and curve D may indicate the relationship between the coefficient of performance indicator 4 and the penalty parameters.

It should be noted that as the penalty parameter increases, the absolute value of the coefficient of the performance indicator corresponding to each curve in the embodiment shown in FIG. 3 will be smaller and smaller. After the penalty parameter is greater than a preset parameter value, the coefficient of each performance indicator will be 0.

It should be noted that, in the embodiment shown in FIG. 3, the later the vertical coordinate of the curve becomes 0, the greater the influence degree of the performance indicator corresponding to the curve on the business indicator. For example, in the embodiment shown in FIG. 3, the performance indicator corresponding to curve D has the greatest influence degree on the business indicator, while the performance indicator corresponding to curve A has the least influence degree on the business indicator.

Optionally, the initial performance indicators are the N indicators that have the greatest influence degree on the business indicator. For example, after the terminal device processes the historical business data based on the lasso linear regression method, it is determined that 30 performance indicators will affect the business indicator, and the terminal device may determine the 10 performance indicators that have the greatest influence on the business indicator as the initial performance indicators.

Optionally, the preset value may be 0, and the terminal device may sort the multiple performance indicators based on the order in which the influence degree becomes 0. For example, the later the influence degree of the performance indicator on the business indicator becomes 0, the higher the order of the performance indicator. For example, in the embodiment shown in FIG. 3, curve A corresponds to performance indicator 1, curve B corresponds to performance indicator 2, curve C corresponds to performance indicator 3, and curve D corresponds to performance indicator 4. Since the influence degree of curve D becomes 0 the latest, during sorting, the sorted first performance indicator is performance indicator 4, similarly, the sorted second performance indicator is performance indicator 3, the sorted third performance indicator is performance indicator 2, and the sorted fourth performance indicator is performance indicator 1. If N is equal to 2, then the terminal device may determine performance indicator 3 and performance indicator 4 as the initial performance indicators.

Optionally, the relevancy may be used for indicating a relevancy degree between the performance indicators. For example, the video playback frame rate and the video fluency will affect each other, so the relevancy between the video playback frame rate and the video fluency is higher. For example, the video playback frame rate and a storage space do not affect each other, so the relevancy between the video playback frame rate and the storage space is lower.

The relevancies between multiple performance indicators to be selected are less than a preset relevancy. For example, the degree of interaction between multiple performance indicators to be selected determined by the terminal device is smaller, so that the problem of multicollinearity can be avoided, and the accuracy of the target performance indicators is further improved.

Optionally, determining, by the terminal device, multiple performance indicators to be selected in multiple initial performance indicators according to the relevancies between the multiple initial performance indicators may specifically include: determining the relevancy between every two initial performance indicators, and performing deduplication processing on the multiple initial performance indicators according to the relevancy between every two initial performance indicators to acquire the multiple performance indicators to be selected.

Optionally, the terminal device may determine the relevancy between every two initial performance indicators based on a preset relevancy relationship between the performance indicators. For example, the terminal device may acquire all performance indicators in advance, and determine the relevancy between every two performance indicators to acquire a relevancy set. Therefore, after the terminal device acquires multiple initial performance indicators, the relevancy between every two initial performance indicators can be determined based on the relevancy set.

Optionally, the terminal device may also determine the relevancy between two initial performance indicators based on any other feasible implementation (for example, determining the relevancy between two initial performance indicators based on the variance expansion coefficient), which is not limited by the embodiment of the present disclosure.

The deduplication processing may be used for deleting one of two initial performance indicators between which the relevancy is greater than or equal to the preset relevancy. For example, if the relevancy between initial performance indicator 1 and initial performance indicator 2 is greater than or equal to the preset relevancy, the terminal device may perform deduplication processing on initial performance indicator 1 and initial performance indicator 2 and keep initial performance indicator 1 or initial performance indicator 2. For example, the terminal device acquires initial performance indicator 1, initial performance indicator 2, initial performance indicator 3 and initial performance indicator 4 based on multiple influence degree curves. If the relevancy between initial performance indicator 3 and initial performance indicator 4 is greater than or equal to the preset relevancy, and the relevancies between other initial performance indicators are less than the preset relevancy, then after the terminal device performs deduplication processing on the multiple initial performance indicators, the acquired performance indicators to be selected may be: initial performance indicator 1, initial performance indicator 2 and initial performance indicator 3, and the performance indicators to be selected acquired by the terminal device may also be: initial performance indicator 1, initial performance indicator 2 and initial performance indicator 4. In this way, based on the deduplication processing, the problem of collinearity can be effectively avoided, the accuracy of determining the target performance indicators is improved, and then the accuracy of the alarm threshold can be improved.

Optionally, the terminal device may process multiple performance indicators to be selected based on the multiple linear regression method to acquire the P value of each performance indicator to be selected. For example, the terminal device may process the multiple performance indicators to be selected based on any feasible multiple linear regression method, which is not limited by the embodiment of the present disclosure. Moreover, after the terminal device processes the multiple performance indicators to be selected based on the multiple linear regression method, not only the P value of each performance indicator to be selected can be acquired, but also the regression coefficient of each performance indicator to be selected can be acquired.

Optionally, the terminal device may determine the performance indicator to be selected of which the P value is less than or equal to the preset threshold as the target performance indicator. For example, the preset threshold may be 0.05. If the P value of the performance indicator to be selected is less than or equal to 0.05, it means that there is a significant difference between the regression coefficient of the performance indicator to be selected and 0 (the preset value). Therefore, the performance indicator to be selected has a greater influence on the business indicator, and the terminal device can determine this performance indicator to be selected as the target performance indicator. If the P value of the performance indicator to be selected is greater than 0.05, it means that there is no significant difference between the regression coefficient of the performance indicator to be selected and 0. Therefore, the performance indicator to be selected has a smaller influence on the business indicator, and this performance indicator to be selected is not the target performance indicator. For example, the preset threshold is 0.05. If the P value of performance indicator 1 to be selected is 0.01, the P value of performance indicator 2 to be selected is 0.05, and the P value of performance indicator 3 to be selected is 0.08, then the terminal device may determine performance indicator 1 to be selected and performance indicator 2 to be selected as the target performance indicators.

It should be noted that the preset threshold may be any set value, which is not limited by the embodiment of the present disclosure.

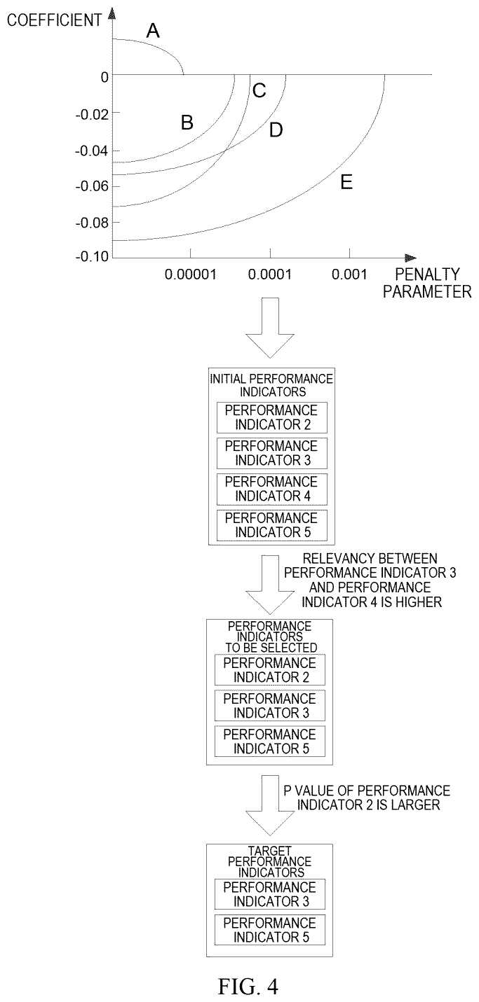

Next, in combination with FIG. 4, the process of determining the target performance indicator will be described.

FIG. 4 is a schematic diagram of a process of determining the target performance indicator according to an embodiment of the present disclosure. Please refer to FIG. 4, a coordinate system is included. A vertical axis of the coordinate system may be the coefficients of the performance indicators, and a horizontal axis of the coordinate system may be penalty parameters. The coordinate system may include curve A, curve B, curve C, curve D and curve E, wherein curve A corresponds to performance indicator 1, curve B to performance indicator 2, curve C to performance indicator 3, curve D to performance indicator 4 and curve E to performance indicator 5.

Please refer to FIG. 4, where N is 4. Since curve A corresponding to performance indicator 1 first becomes 0, the terminal device (not shown in FIG. 4) may determine that the initial performance indicators may include performance indicator 2, performance indicator 3, performance indicator 4 and performance indicator 5. Due to the higher relevancy between performance indicator 3 and performance indicator 4, the terminal device may determine that the performance indicators to be selected may include performance indicator 2, performance indicator 3 and performance indicator 5.

Please refer to FIG. 4. The terminal device may perform multiple linear regression processing (a relationship with the business indicator) on performance indicator 2, performance indicator 3 and performance indicator 5, to acquire the P value corresponding to each performance indicator. Since the P value of performance indicator 2 is larger, the terminal device may determine the target performance indicators as performance indicator 3 and performance indicator 5. In addition, the regression coefficient of each performance indicator may be acquired during multiple linear regression processing. Therefore, the terminal device can also acquire the regression coefficient of performance indicator 3 and the regression coefficient of performance indicator 5.

In this way, the terminal device can determine two performance indicators having the greatest influence on the business indicator in multiple performance indicators, and there is no problem of multicollinearity between performance indicator 3 and performance indicator 5, which can further improve the accuracy of determining the alarm threshold of the performance indicators and the alarm accuracy of the performance indicators.

S203: according to the regression coefficient of each target performance indicator and a minimum difference value of a significant change of the business indicator, a maximum acceptable deterioration value corresponding to each target performance indicator is determined.

The minimum difference value of the significant change is used for indicating the value by which the business indicator can change significantly. For example, after the business indicator changes by the minimum difference value of the significant change, the terminal device may determine that the business indicator changes significantly. For example, the minimum difference value of the significant change of the number of daily active users is 30. If the number of daily active users is increased by 30, then the terminal device may determine that the number of daily active users changes significantly (that is, the business indicator may change in an experimental process of the performance indicator), and if the number of daily active users is decreased by 1, then the terminal device may determine that the number of daily active users does not change significantly.

Optionally, the terminal device may determine the minimum difference value of the significant change based on the following feasible implementation: determining multiple indicator values of the business indicator, determining an indicator average value and an indicator variance value corresponding to the business indicator according to the multiple indicator values of the business indicator, and determining the minimum difference value of the significant change corresponding to the business indicator according to the indicator average value and the indicator variance value corresponding to the business indicator by means of T-test.

Optionally, the terminal device may determine the multiple indicator values of the business indicator, and the indicator average value and the indicator variance value corresponding to the business indicator based on any feasible implementation, which is not limited by the embodiment of the present disclosure.

Optionally, the terminal device may determine the minimum difference value of the significant change based on the following formula:

$$t = \frac{( {\overline{x}}_{1} - {\overline{x}}_{2} ) - ( {μ}_{1} + {μ}_{2} )}{\sqrt{\frac{{s}_{1}^{2}}{{n}_{1}} + \frac{{s}_{2}^{2}}{{n}_{2}}}} ,$$

wherein x̅₁ is the indicator average value of an experimental group, x̅₂ is the indicator average value of a control group, μ₁−μ₂ is a difference value (the value may be 0) between the actual indicator average value of the experimental group and the indicator average value of the control group, s₁ is the indicator variance value of the experimental group, s₁ is the indicator variance value of the control group, n₁ is the number of users of the experimental group, and n₂ is the number of users of the control group.

Based on the above formula, the terminal device can determine the minimum difference value of the significant change corresponding to the business indicator. It should be noted that during the experiment, the minimum difference value of the significant change is different with different confidence levels. For example, the lower the confidence level, the higher the accuracy of the minimum difference value of the significant change. For example, when the confidence level is 5%, the minimum difference value of the significant change of the business indicator is numerical value A, and when the confidence level is 10%, the minimum difference value of the significant change of the business indicator is numerical value B. Based on the above formula, if the experimental group and the control group have the same variance and the same number of users, the ratio of numerical value B to numerical value A is about \sqrt{2}.

Optionally, after the terminal device determines the regression coefficient of the target performance indicator and the minimum difference value of the significant change of the business indicator, for any target performance indicator, the terminal device may determine the maximum acceptable deterioration value corresponding to the target performance indicator based on the following feasible implementation: determining a ratio of the minimum difference value to the regression coefficient of the target performance indicator, and determining the ratio as the maximum acceptable deterioration value corresponding to the target performance indicator.

Optionally, the terminal device may determine the maximum acceptable deterioration value corresponding to the target performance indicator based on the following formula:

$$A = \frac{{X}_{min}}{{β}_{x}} ,$$

wherein A is the maximum acceptable deterioration value, Xₘᵢₙ is the minimum difference value of the significant change, and βₓ is the regression coefficient corresponding to the target performance indicator.

Based on the above formula, the terminal device can determine the maximum acceptable deterioration value corresponding to each target performance indicator, and then give an alarm to the change of the target performance indicator based on the maximum acceptable deterioration value corresponding to each target performance indicator, thereby improving the alarm accuracy. For example, the maximum acceptable deterioration value of target performance indicator 1 is numerical value A, and the maximum acceptable deterioration value of target performance indicator 2 is numerical value B. If target performance indicator 1 is increased by numerical value A when the terminal device adjusts other performance indicators, then the terminal device may give an alarm to target performance indicator 1. If target performance indicator 2 is decreased by numerical value B when the terminal device adjusts other performance indicators, then the terminal device may give an alarm to the target performance indicator 2. After giving an alarm, the terminal device may stop adjusting other performance indicators, or may determine whether to stop adjusting other performance indicators based on optimization and deterioration results of the business indicator after the change of the target performance indicator, which is not limited by the embodiment of the present disclosure.

The embodiment of the present disclosure provides a method of processing performance indicators. The terminal device can acquire the historical business data and process the historical business data according to a lasso linear regression method, and then determine multiple performance indicators to be selected in the multiple performance indicators. The terminal device can process the multiple performance indicators to be selected by the multiple linear regression method to acquire the P value of each performance indicator to be selected and the regression coefficient of each performance indicator to be selected, and determine the performance indicator to be selected of which the P value is less than or equal to the preset threshold as the target performance indicator. The terminal device can determine the maximum acceptable deterioration value corresponding to each target performance indicator according to the regression coefficient of each target performance indicator and the minimum difference value of the significant change of the business indicator. In the above method, since the target performance indicator has greater influence on the business indicator, the terminal device can accurately acquire the maximum acceptable deterioration value of the target performance indicator according to the ratio of the minimum difference value of the significant change of the business indicator to the regression coefficient of the target performance indicator, which improves the accuracy of the maximum acceptable deterioration value, and improves the alarm accuracy of the target performance indicator.

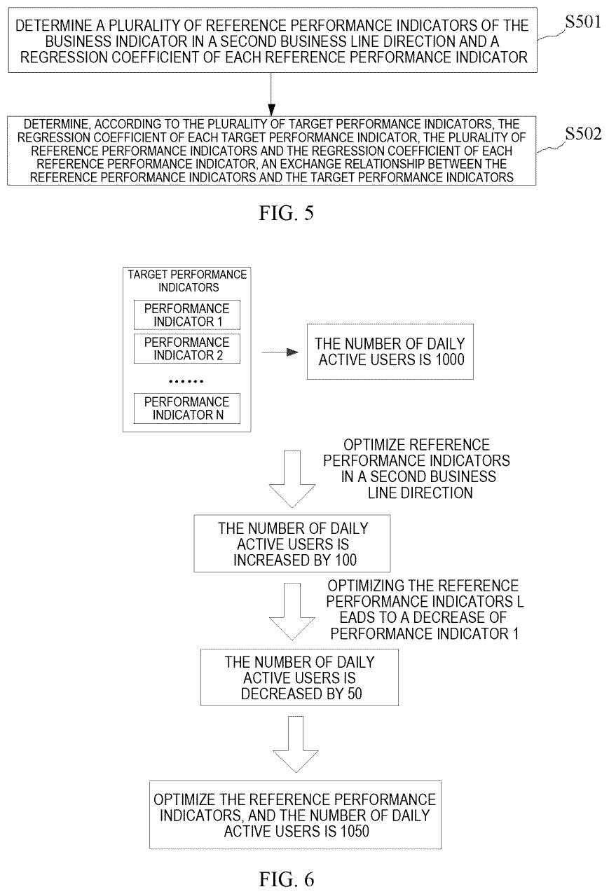

Based on the embodiment shown in FIG. 2, the above method of processing performance indicators also includes a method of determining an exchange relationship between the performance indicators. Next, in combination with FIG. 5, the method of determining the exchange relationship between the performance indicators will be described.

FIG. 5 is a schematic diagram of a method of determining an exchange relationship according to an embodiment of the present disclosure. Please refer to FIG. 5, the method includes the following steps.

S501: multiple reference performance indicators of the business indicator in a second business line direction and a regression coefficient of each reference performance indicator are determined.

Optionally, the multiple performance indicators may be multiple indicators of the business indicator in a first business line direction. For example, the historical business data acquired by the terminal device may be multiple indicators of the first business line direction, and the first business line direction may be influences of the client side performance indicators, the playback performance indicators and the production side performance indicators on the business indicator.

Optionally, the second business line direction is different from the first business line direction. For example, the second business line direction may be an influence of comment-optimized indicators on the business indicator, an influence of UI-optimized indicators on the business indicator, etc. For example, the first business line direction may be the influence of the video playback frame rate on the number of daily active users, and the second business line direction may be the influence of voice comments changed from text comments on the number of daily active users.

Optionally, the reference performance indicators may be the performance indicators of the second business line direction. For example, the second business line direction is the direction of UI interaction optimization, and the reference performance indicators may be comment indicators, which is not limited by the embodiment of the present disclosure.

Optionally, the regression coefficient of the reference performance indicator may be used for indicating the influence degree of the reference performance indicator on the business indicator. For example, the greater the regression coefficient of the reference performance indicator, the greater the influence degree of the reference performance indicator on the business indicator, and the smaller the regression coefficient of the reference performance indicator, the smaller the influence degree of the reference performance indicator on the business indicator.

It should be noted that the method of determining, by the terminal device, the multiple reference performance indicators in the second business line direction and the regression coefficient of each reference performance indicator is the same as the method of determining, by the terminal device, the multiple target performance indicators in the first business line direction and the regression coefficient of each target performance indicator, which will not be repeated in detail by the embodiment of the present disclosure here.

S502: according to the multiple target performance indicators, the regression coefficient of each target performance indicator, the multiple reference performance indicators and the regression coefficient of each reference performance indicator, the exchange relationship between the reference performance indicators and the target performance indicators is determined.

The exchange relationship may be used for indicating whether the reference performance indicators are adjustable. For example, in an actual application process, when the terminal device adjusts the reference performance indicators in the second business line direction, the target performance indicators in the first business line direction are possibly affected, and the value of the business indicator will also change after the target performance indicators change. Therefore, the terminal device can determine whether to adjust the reference performance indicators in the second business line direction based on the exchange relationship.

Optionally, for any target performance indicator in the first business line direction, the terminal device may determine an adjustable ratio between the reference performance indicator and the target performance indicator based on the following feasible implementation: determining a ratio between the regression coefficient of the target performance indicator and the regression coefficient of the reference performance indicator, acquiring a deterioration ratio of the target performance indicator after the reference performance indicator is adjusted, and determining whether the reference performance indicator is adjustable based on the deterioration ratio and the ratio between the regression coefficient of the target performance indicator and the regression coefficient of the reference performance indicator.

Optionally, when the terminal device optimizes the reference performance indicator in the second business line direction, if the optimization of the reference performance indicator will lead to the deterioration of the target performance indicator in the first business line direction, then the terminal device may acquire the deterioration ratio of the target performance indicator, and then determine whether to optimize the reference performance indicator based on the deterioration ratio and the ratio between the regression coefficient of the target performance indicator and the regression coefficient of the reference performance indicator. For example, when the target performance indicator is deteriorated by 1%, the terminal device can adjust the reference performance indicator only when the optimization of the reference performance indicator exceeds the ratio between the regression coefficient of the target performance indicator and the regression coefficient of the reference performance indicator.

For example, the first business line direction: business indicator=A*target performance indicator 1+B*target performance indicator 2+C*target performance indicator 3, and the second business line direction: business indicator=a*reference performance indicator 1+b*reference performance indicator 2. If the terminal device needs to optimize reference performance indicator 1, and the optimization of reference performance indicator 1 leads to the deterioration of 1% of target performance indicator 1, then the terminal device may optimize reference performance indicator 1 when the optimization of reference performance indicator 1 is greater than the ratio of A to a.

For example, the business indicator is the number of daily active users, the first business line direction: the number of daily active users=A*target performance indicator 1+B*target performance indicator 2+C*target performance indicator 3, the second business line direction: the number of daily active users=a*reference performance indicator 1+b*reference performance indicator 2. When the terminal device optimizes reference performance indicator 1, the number of daily active users can be increased by 50. However, when the terminal device optimizes reference performance indicator 1, it will deteriorate target performance indicator 1. If the number of daily active users is decreased by 100 after the deterioration of target performance indicator 1, then the terminal device will stop optimizing reference performance indicator 1. If the number of daily active users is decreased by 10 after the deterioration of target performance indicator 1, then the terminal device can optimize reference performance indicator 1.

Next, in combination with FIG. 6, the optimization process of the reference performance indicators by the terminal device will be explained.

FIG. 6 is a schematic diagram of an optimization process of the reference performance indicators according to an embodiment of the present disclosure. Please refer to FIG. 6, the target performance indicators of the first business line direction are included. The target performance indicators may include performance indicator 1, performance indicator 2, . . . , and performance indicator n. Based on the target performance indicators, the terminal device (not shown in FIG. 6) determines that the number of daily active users is 1000.

Please refer to FIG. 6, if the terminal device optimizes the reference performance indicators in the second business line direction, the number of daily active users can be increased by 100 by the optimization of the reference performance indicators. However, the optimization of the reference performance indicators will lead to the decrease of performance indicator 1 in the first business line direction, and the decrease of performance indicator 1 will lead to the decrease of 50 of the number of daily active users.

Please refer to FIG. 6. Since the number of users increased after the optimization of the reference performance indicators is greater than the number of users decreased after the deterioration of performance indicator 1, the terminal device can optimize the reference performance indicators. After the terminal device optimizes the reference performance indicators, the number of daily active users is 1050 (increased by 100 after the optimization of the reference performance indicators, and decreased by 50 after the deterioration of performance indicator 1). In this way, the terminal device can accurately determine whether to adjust the reference performance indicators based on the exchange relationship, thereby improving the optimization accuracy of the performance indicators.

The embodiment of the present disclosure provides a method of determining the exchange relationship. The terminal device can determine multiple reference performance indicators of the business indicator in the second business line direction and the regression coefficient of each reference performance indicator, and determine the exchange relationship between the reference performance indicators and the target performance indicators according to the multiple target performance indicators, the regression coefficient of each target performance indicator, the multiple reference performance indicators and the regression coefficient of each reference performance indicator. In this way, when optimizing the performance indicators in other business line directions, the terminal device can determine whether to optimize the performance indicators in other business line directions based on the exchange relationship. In this way, the situation that optimizing the performance indicators in other business line directions leads to the deterioration of the business indicator can be avoided, and the optimization accuracy of the business indicator is improved.

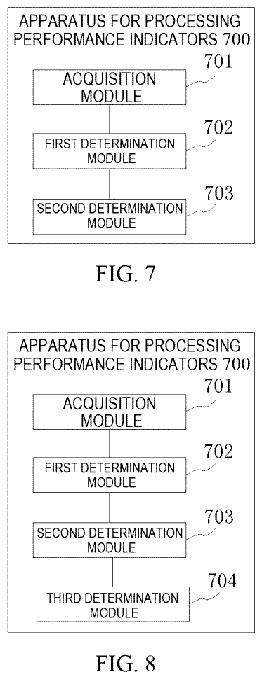

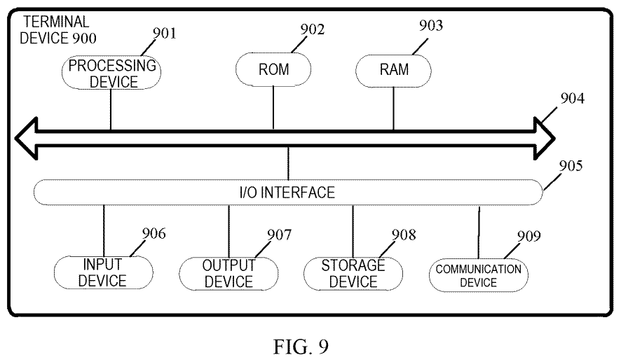

FIG. 7 is a schematic structural diagram of an apparatus for processing performance indicators according to an embodiment of the present disclosure. As can be seen in FIG. 7, the apparatus 700 for processing performance indicators comprises an acquisition module 701, a first determination module 702 and a second determination module 703, wherein:
the acquisition module 701 is configured for acquiring historical business data comprising a value of a business indicator of an application program when a plurality of performance indicators have different values;
the first determination module 702 is configured for determining, according to the historical business data, a plurality of target performance indicators in the plurality of performance indicators and determining a regression coefficient of each target performance indicator, the regression coefficient being used for indicating an influence degree of the target performance indicator on the business indicator; and
the second determination module 703 is configured for determining, according to the regression coefficient of each target performance indicator and a minimum difference value of a significant change of the business indicator, a maximum acceptable deterioration value corresponding to each target performance indicator.

According to one or more embodiments of the present disclosure, the second determination module 702 is specifically configured to:
determining, by a multiple linear regression method, a plurality of performance indicators to be selected in the plurality of performance indicators;
determining a regression coefficient of each performance indicator to be selected; and
determining, in the plurality of performance indicators, performance indicators to be selected of which the regression coefficient is greater than or equal to a preset threshold as the plurality of target performance indicators.

According to one or more embodiments of the present disclosure, the first determination module 702 is specifically configured to:
processing, by the multiple linear regression method, the historical business data to acquire an influence degree curve of each performance indicator on the business indicator;
sorting, according to a plurality of influence degree curves, the plurality of performance indicators in an order in which the influence degree becomes a preset value, and determining first N performance indicators in the sorted plurality of performance indicators as a plurality of initial performance indicators, N being an integer greater than 1; and
determining, according to relevancies between the plurality of initial performance indicators, the plurality of performance indicators to be selected in the plurality of initial performance indicators, relevancies between the plurality of performance indicators to be selected being less than a preset relevancy

According to one or more embodiments of the present disclosure, the first determination module 702 is specifically configured to:
determining the relevancy between every two initial performance indicators; and
performing, according to the relevancy between every two initial performance indicators, deduplication processing on the plurality of initial performance indicators to acquire the plurality of performance indicators to be selected; the deduplication processing being used for deleting one of two initial performance indicators between which the relevancy is greater than or equal to the preset relevancy

According to one or more embodiments of the present disclosure, the second determination module 703 is specifically configured to:
determining a ratio of the minimum difference value to the regression coefficient of the target performance indicator; and
determining the ratio as the maximum acceptable deterioration value corresponding to the target performance indicator.

According to one or more embodiments of the present disclosure, the second determination module 703 is specifically configured to:
determining a plurality of indicator values of the business indicator;
determining, according to the plurality of indicator values of the business indicator, an indicator average value and an indicator variance value corresponding to the business indicator; and
determining, according to the indicator average value and the indicator variance value corresponding to the business indicator, the minimum difference value of the significant change corresponding to the business indicator by means of T-test.

The apparatus for processing performance indicators provided by the embodiments of the present disclosure may be used to perform the technical solutions of the above method embodiments. Its implementation principles and technical effects are similar and will not be described again here.

FIG. 8 is a schematic structural diagram of another apparatus for processing performance indicators according to an embodiment of the present disclosure. On the basis of the embodiment illustrated in FIG. 7, the apparatus 700 for processing performance indicators further comprises a third determination module 704, wherein the third determination module 704 is configured for:
determining a plurality of reference performance indicators of the business indicator in a second business line direction and a regression coefficient of each reference performance indicator; and
determining, according to the plurality of target performance indicators, the regression coefficient of each target performance indicator, the plurality of reference performance indicators and the regression coefficient of each reference performance indicator, an exchange relationship between the reference performance indicators and the target performance indicators, the exchange relationship being used for indicating whether the reference performance indicators are adjustable.

The apparatus for processing performance indicators provided by the embodiments of the present disclosure may be used to perform the technical solutions of the above method embodiments. Its implementation principles and technical effects are similar and will not be described again here.

Referring to FIG. 5, which is a schematic structural diagram of an electronic device 500 suitable for implementing the embodiments of the present disclosure. The electronic device in the embodiments of the present disclosure may include, but is not limited to, mobile terminals such as a mobile phone, a notebook computer, a digital broadcast receiver, a personal digital assistant (PDA), a PAD (tablet computer), a portable media player (PMP) and a vehicle-mounted terminal (for example, a vehicle-mounted navigation terminal), and fixed terminals such as a digital television (TV) and a desktop computer. The electronic device shown in FIG. 5 is merely an example and should not impose any restrictions on the functions and scope of use of the embodiments of the present application.

As shown in FIG. 5, the electronic device 500 may include a processing device (such as a central processing unit and a graphics processor) 501, which may execute various appropriate actions and processing according to a program stored in a read-only memory (ROM) 502 or a program loaded to a random access memory (RAM) 503 from a storage device 508. Various programs and data required during operation of the electronic device 500 are also stored in the RAM 503. The processing device 501, the ROM 502 and the RAM 503 are connected with one another via a bus 504. An input/output (I/O) interface 505 is also connected to the bus 504.

Generally, the following apparatuses may be connected to the I/O interface 505: an input device 506 including for example a touch screen, a touch pad, a keyboard, a mouse, a camera, a microphone, an accelerometer and a gyroscope; an output device 507 including for example a liquid crystal display (LCD), a speaker and a vibrator; a storage device 508 including for example a magnetic tape and a hard disk; and a communication device 509. The communication device 509 may allow wireless or wired communication between the electronic device 500 and other devices for data exchange. Although FIG. 5 shows the electronic device 500 having various devices, it should be understood that not all the devices shown are necessarily required to be implemented or provided. More or fewer devices may alternatively be implemented or provided.

In particular, according to the embodiments of the present disclosure, the process described above with reference to the flowcharts may be implemented as a computer software program. For example, an embodiment of the present disclosure provides a computer program product including a computer program carried on a non-transient computer-readable medium. The computer program includes a program code for executing the methods shown in the flowcharts. In such an embodiment, the computer program may be downloaded and installed from the network via the communication device 509, or installed from the storage device 508, or installed from the ROM 502. The computer program, when executed by the processing unit 501, causes the processing unit to execute the above functions defined in the methods according to the embodiments of the present disclosure.

It should be noted that the computer-readable medium according to the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus, or device, or any combination thereof. More specific examples of the computer-readable storage medium include but are not limited to: an electrical connection with at least one wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program. The program may be used by or used in combination with an instruction execution system, apparatus, or device. However, in the present disclosure, the computer-readable signal medium may include a data signal propagated in baseband or as a part of a carrier wave, and computer-readable program code is carried therein. This propagated data signal may take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program used by or used in combination with the instruction execution system, apparatus, or device. The program code contained on the computer-readable medium may be transmitted by any suitable medium, including but not limited to, wire, optical cable, RF, etc., or any suitable combination thereof.

The computer-readable medium may be included in the electronic device described above; or it may stand alone without being assembled into the electronic device.

The computer-readable medium carries one or more programs. When the one or more programs are executed by the electronic device, the electronic device performs the method of the embodiments above.

The embodiments of the present disclosure provide a computer-readable storage medium. Computer-executable instructions are stored in the computer-readable storage medium, and a processor, when executing the computer-executable instructions, implements the method that may be involved in the embodiments above.

The present disclosure provides a method, apparatus and terminal device for processing performance indicators. The terminal device can acquire the historical business data, wherein the historical business data includes the value of the business indicator of an application program when multiple performance indicators have different values, according to the historical business data, a plurality of target performance indicators in the multiple performance indicators and the regression coefficient of each target performance indicator are determined, wherein the regression coefficient is used for indicating the influence degree of the target performance indicator on the business indicator. According to the regression coefficient of each target performance indicator and the minimum difference value of the significant change of the business indicator, the maximum acceptable deterioration value corresponding to each target performance indicator is determined. In the above method, since the terminal device can accurately determine the maximum acceptable deterioration value corresponding to each performance indicator within the range of the minimum difference value of the significant change of the business indicator in combination with relationships between multiple performance indicators and the business indicator, the accuracy of the maximum acceptable deterioration value is higher, and the terminal device can give an alarm to each performance indicator based on the maximum acceptable deterioration value, thereby improving the alarm accuracy of the performance indicator.

The embodiments of the present disclosure provide a computer program product which includes a computer program, when executed by a processor, implementing the method that may be involved in the embodiments above.

The computer program code for performing the operations of the present disclosure may be written in one or more programming languages or a combination thereof, which include but are not limited to object-oriented programming languages Java, Smalltalk, C++, and conventional procedural programming languages such as “C” or similar programming languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

The flowcharts and the block diagrams in the drawings illustrate system architectures, functions and operations that may be implemented based on the system, method, and computer program product according to various embodiments of the present disclosure. In this regard, each block in the flowcharts or the block diagrams can represent one module, a program segment or a part of a code, and the module, the program segment or the part of the code includes at least one executable instruction for implementing specific logic functions. It should also be noted that, in some alternative implementations, the functions noted in the blocks may also occur in a sequence different from those illustrated in the drawings. For example, two consecutive blocks may be executed substantially in parallel, and may sometimes be executed in an opposite order, depending on the functions involved. It should also be noted that each block in the block diagrams and/or the flowcharts, and combinations of the blocks in the block diagrams and/or the flowcharts can be implemented in a dedicated hardware-based system that performs the specified functions or operations, or can be implemented by the combination of dedicated hardware and computer instructions.

The units involved in the embodiments described in this application may be implemented in software or hardware. Herein, the name of the unit/module does not constitute a limitation on the unit itself in some cases. For example, a first acquisition unit may further be described as “a unit that acquires at least two Internet Protocol addresses”.

The functions described above herein may be at least partially performed by one or more hardware logic components. For example, non-restrictively, example types of hardware logic components that may be used include: a field programmable gate array (FPGA), an application-specific integrated circuit (ASIC), an application-specific standard parts (ASSP), a system-on-chip (SOC), a complex programmable logic device (CPLD), and the like.

In the context of the present disclosure, the machine-readable medium may be a tangible medium that may contain or store a program used by or used in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

It should be noted that the modifications of “one” and “a plurality of” mentioned in this disclosure are illustrative but not limiting. Those skilled in the art should understand that unless otherwise indicated in the context, they should be understood as “one or more”.

The names of the messages or information interacted between a plurality of apparatuses in this public implementation are for illustrative purposes only, which are not intended to limit the scope of these messages or information.

It may be understood that before using the technical solutions disclosed in each embodiment of the present application, the user should be informed of the type, scope of use, usage scenarios, etc. of the personal information involved in the present application in an appropriate manner in accordance with relevant laws and regulations, and the user's authorization should be obtained.

For example, in response to receiving an active request from a user, prompt information is sent to the user to clearly remind the user that the operation requested to be performed will require obtaining and using the user's personal information. Therefore, users may autonomously choose whether to provide personal information to software or hardware such as electronic devices, applications, servers or storage medium that perform the operations of the technical solution of the present application based on the prompt information. As an optional but non-limiting implementation, in response to receiving the user's active request, a method of sending prompt information to the user may be, for example, a pop-up window, and the prompt information may be presented in the form of text in the pop-up window. In addition, the pop-up window may also contain a selection control for the user to choose “agree” or “disagree” to provide personal information to the electronic device.

It may be understood that the above notification and obtaining user authorization processes are only illustrative and do not limit the implementations of the present application. Other methods that meet relevant laws and regulations may also be applied to the implementations of the present application.

It may be understood that the data involved in this technical solution (including but not limited to the data itself, the obtaining or use of the data) should comply with the requirements of corresponding laws, regulations and related regulations. Data may include information, parameters, messages, etc., such as flow switching instruction information.

In a first aspect, according to one or more embodiments of the present disclosure, the present disclosure comprises a method of processing performance indicators, comprising:
acquiring historical business data comprising a value of a business indicator of an application program when a plurality of performance indicators have different values;
determining, according to the historical business data, a plurality of target performance indicators in the plurality of performance indicators and determining a regression coefficient of each target performance indicator, the regression coefficient being used for indicating an influence degree of the target performance indicator on the business indicator; and
determining, according to the regression coefficient of each target performance indicator and a minimum difference value of a significant change of the business indicator, a maximum acceptable deterioration value corresponding to each target performance indicator.

According to one or more embodiments of the present disclosure, wherein determining, according to the historical business data, a plurality of target performance indicators in the plurality of performance indicators comprises:
determining, by a multiple linear regression method, a plurality of performance indicators to be selected in the plurality of performance indicators;
determining a regression coefficient of each performance indicator to be selected; and
determining, in the plurality of performance indicators, performance indicators to be selected of which the regression coefficient is greater than or equal to a preset threshold as the plurality of target performance indicators.

According to one or more embodiments of the present disclosure, wherein determining, by a multiple linear regression method, a plurality of performance indicators to be selected in the plurality of performance indicators comprises:
processing, by the multiple linear regression method, the historical business data to acquire an influence degree curve of each performance indicator on the business indicator;
sorting, according to a plurality of influence degree curves, the plurality of performance indicators in an order in which the influence degree becomes a preset value, and determining first N performance indicators in the sorted plurality of performance indicators as a plurality of initial performance indicators, N being an integer greater than 1; and
determining, according to relevancies between the plurality of initial performance indicators, the plurality of performance indicators to be selected in the plurality of initial performance indicators, relevancies between the plurality of performance indicators to be selected being less than a preset relevancy

According to one or more embodiments of the present disclosure, wherein determining, according to relevancies between the plurality of initial performance indicators, the plurality of performance indicators to be selected in the plurality of initial performance indicators comprises:
determining the relevancy between every two initial performance indicators; and
performing, according to the relevancy between every two initial performance indicators, deduplication processing on the plurality of initial performance indicators to acquire the plurality of performance indicators to be selected; the deduplication processing being used for deleting one of two initial performance indicators between which the relevancy is greater than or equal to the preset relevancy

According to one or more embodiments of the present disclosure, wherein for any target performance indicator, determining, according to the regression coefficient of each target performance indicator and a minimum difference value of a significant change of the business indicator, a maximum acceptable deterioration value corresponding to each target performance indicator comprises:
determining a ratio of the minimum difference value to the regression coefficient of the target performance indicator; and
determining the ratio as the maximum acceptable deterioration value corresponding to the target performance indicator.

According to one or more embodiments of the present disclosure, wherein before determining, according to the regression coefficient of each target performance indicator and the minimum difference value of the significant change of the business indicator, the maximum acceptable deterioration value corresponding to each target performance indicator, the method further comprises:
determining a plurality of indicator values of the business indicator;
determining, according to the plurality of indicator values of the business indicator, an indicator average value and an indicator variance value corresponding to the business indicator; and
determining, according to the indicator average value and the indicator variance value corresponding to the business indicator, the minimum difference value of the significant change corresponding to the business indicator by means of T-test.

According to one or more embodiments of the present disclosure, wherein the plurality of performance indicators are a plurality of indicators of the business indicator in a first business line direction; the method further comprises:
determining a plurality of reference performance indicators of the business indicator in a second business line direction and a regression coefficient of each reference performance indicator; and
determining, according to the plurality of target performance indicators, the regression coefficient of each target performance indicator, the plurality of reference performance indicators and the regression coefficient of each reference performance indicator, an exchange relationship between the reference performance indicators and the target performance indicators, the exchange relationship being used for indicating whether the reference performance indicators are adjustable

In a second aspect, the present disclosure provides an apparatus for processing performance indicators, comprising an acquisition module, a first determination module and a second determination module, wherein:
the acquisition module is configured for acquiring historical business data comprising a value of a business indicator of an application program when a plurality of performance indicators have different values;
the first determination module is configured for determining, according to the historical business data, a plurality of target performance indicators in the plurality of performance indicators and determining a regression coefficient of each target performance indicator, the regression coefficient being used for indicating an influence degree of the target performance indicator on the business indicator; and
the second determination module is configured for determining, according to the regression coefficient of each target performance indicator and a minimum difference value of a significant change of the business indicator, a maximum acceptable deterioration value corresponding to each target performance indicator.

According to one or more embodiments of the present disclosure, the second determination module is specifically configured to:
determining, by a multiple linear regression method, a plurality of performance indicators to be selected in the plurality of performance indicators;
determining a regression coefficient of each performance indicator to be selected; and
determining, in the plurality of performance indicators, performance indicators to be selected of which the regression coefficient is greater than or equal to a preset threshold as the plurality of target performance indicators.

According to one or more embodiments of the present disclosure, the first determination module is specifically configured to:
processing, by the multiple linear regression method, the historical business data to acquire an influence degree curve of each performance indicator on the business indicator;
sorting, according to a plurality of influence degree curves, the plurality of performance indicators in an order in which the influence degree becomes a preset value, and determining first N performance indicators in the sorted plurality of performance indicators as a plurality of initial performance indicators, N being an integer greater than 1; and
determining, according to relevancies between the plurality of initial performance indicators, the plurality of performance indicators to be selected in the plurality of initial performance indicators, relevancies between the plurality of performance indicators to be selected being less than a preset relevancy

According to one or more embodiments of the present disclosure, the first determination module is specifically configured to:
determining the relevancy between every two initial performance indicators; and
   performing, according to the relevancy between every two initial performance indicators, deduplication processing on the plurality of initial performance indicators to acquire the plurality of performance indicators to be selected; the deduplication processing being used for deleting one of two initial performance indicators between which the relevancy is greater than or equal to the preset relevancy

According to one or more embodiments of the present disclosure, the second determination module is specifically configured to:
determining a ratio of the minimum difference value to the regression coefficient of the target performance indicator; and
   determining the ratio as the maximum acceptable deterioration value corresponding to the target performance indicator.

According to one or more embodiments of the present disclosure, the second determination module is specifically configured to:
determining a plurality of indicator values of the business indicator;
determining, according to the plurality of indicator values of the business indicator, an indicator average value and an indicator variance value corresponding to the business indicator; and
   determining, according to the indicator average value and the indicator variance value corresponding to the business indicator, the minimum difference value of the significant change corresponding to the business indicator by means of T-test.

According to one or more embodiments of the present disclosure, the apparatus for processing performance indicators further comprises a third determination module, wherein the third determination module is configured for:
determining a plurality of reference performance indicators of the business indicator in a second business line direction and a regression coefficient of each reference performance indicator; and
determining, according to the plurality of target performance indicators, the regression coefficient of each target performance indicator, the plurality of reference performance indicators and the regression coefficient of each reference performance indicator, an exchange relationship between the reference performance indicators and the target performance indicators, the exchange relationship being used for indicating whether the reference performance indicators are adjustable.

In a third aspect, the embodiments of the present disclosure provide a terminal device comprising: a processor and a memory;
the memory stores computer-executable instructions; and
the processor executes the computer-executable instructions stored in the memory, so that the processor performs a method of processing performance indicators according to the above first aspect or that may be involved in the first aspect.

In a fourth aspect, the embodiments of the present disclosure provide a computer-readable storage medium. Computer-executable instructions are stored in the computer-readable storage medium, and a processor, when executing the computer-executable instructions, implements a method of processing performance indicators according to the above first aspect or that may be involved in the first aspect.

The above description is only for the preferred embodiments of the present disclosure and an explanation of the technical principles used. Those skilled in the art should understand that the scope involved in the present disclosure is not limited to technical solutions formed by specific combinations of the aforementioned technical features, and should also cover other technical solutions formed by any combinations of the aforementioned technical features or their equivalent features without departing from the disclosed concept. For example, a technical solution is formed by replacing the above features with (but not limited to) technical features with similar functions disclosed in this disclosure.

Furthermore, although operations are depicted in a specific order, this should not be understood as requiring that these operations be performed in the specific order shown or performed in a sequential order. In certain environments, multitasking and parallel processing may be advantageous. Likewise, although several specific implementation details are included in the above discussion, these should not be interpreted as limitations on the scope of this disclosure. Certain features described in the context of individual embodiments may also be combined to be implemented in a single embodiment. On the contrary, various features described in the context of a single embodiment may also be implemented separately or in any suitable sub combination in multiple embodiments.

Although the present subject matter has been described in language specific to structural features and/or methodological logical actions, it should be understood that the subject matter defined in the attached claims may not necessarily be limited to the specific features or acts described above. On the contrary, the specific features and actions described above are only example forms of implementing the claims. Regarding the system in the above embodiments, the specific way in which each module performs operations has been described in detail in the embodiments related to this method, and will not be elaborated here.

What is claimed is:

1. A method of processing performance indicators, comprising:
acquiring historical business data comprising a value of a business indicator of an application program when a plurality of performance indicators have different values;
determining, according to the historical business data, a plurality of target performance indicators in the plurality of performance indicators and determining a regression coefficient of each target performance indicator, the regression coefficient being used for indicating an influence degree of the target performance indicator on the business indicator; and
determining, according to the regression coefficient of each target performance indicator and a minimum difference value of a significant change of the business indicator, a maximum acceptable deterioration value corresponding to each target performance indicator.

2. The method of claim 1, wherein determining, according to the historical business data, the plurality of target performance indicators in the plurality of performance indicators comprises:
determining, according to the historical business data, a plurality of performance indicators to be selected in the plurality of performance indicators, a problem of multicollinearity not existing in the plurality of performance indicators to be selected;
processing, by a multiple linear regression method, the plurality of performance indicators to be selected to acquire a P value of each performance indicator to be selected, the P value being used for indicating whether there is a significant difference between the regression coefficient of the performance indicator to be selected and a preset value; and
determining the performance indicator to be selected of which the P value is less than or equal to a preset threshold as the target performance indicator.

3. The method of claim 2, wherein determining, according to the historical business data, the plurality of performance indicators to be selected in the plurality of performance indicators comprises:
processing, by a lasso linear regression method, the historical business data to acquire an influence degree curve of each performance indicator on the business indicator;
sorting, according to a plurality of influence degree curves, the plurality of performance indicators in an order in which the influence degree becomes a preset value, and determining first N performance indicators in the sorted plurality of performance indicators as a plurality of initial performance indicators, N being an integer greater than 1; and
determining, according to relevancies between the plurality of initial performance indicators, the plurality of performance indicators to be selected in the plurality of initial performance indicators, relevancies between the plurality of performance indicators to be selected being less than a preset relevancy.

4. The method of claim 3, wherein determining, according to the relevancies between the plurality of initial performance indicators, the plurality of performance indicators to be selected in the plurality of initial performance indicators comprises:
determining the relevancy between every two initial performance indicators; and
performing, according to the relevancy between every two initial performance indicators, deduplication processing on the plurality of initial performance indicators to acquire the plurality of performance indicators to be selected; the deduplication processing being used for deleting one of two initial performance indicators between which the relevancy is greater than or equal to the preset relevancy.

5. The method of claim 1, wherein for any target performance indicator, determining, according to the regression coefficient of each target performance indicator and the minimum difference value of the significant change of the business indicator, the maximum acceptable deterioration value corresponding to each target performance indicator comprises:
determining a ratio of the minimum difference value to the regression coefficient of the target performance indicator; and
determining the ratio as the maximum acceptable deterioration value corresponding to the target performance indicator.

6. The method of claim 1, wherein before determining, according to the regression coefficient of each target performance indicator and the minimum difference value of the significant change of the business indicator, the maximum acceptable deterioration value corresponding to each target performance indicator, the method further comprises:
determining a plurality of indicator values of the business indicator;
determining, according to the plurality of indicator values of the business indicator, an indicator average value and an indicator variance value corresponding to the business indicator; and
determining, according to the indicator average value and the indicator variance value corresponding to the business indicator, the minimum difference value of the significant change corresponding to the business indicator by means of T-test.

7. The method of claim 1, wherein the plurality of performance indicators are a plurality of indicators of the business indicator in a first business line direction; the method further comprises:
determining a plurality of reference performance indicators of the business indicator in a second business line direction and a regression coefficient of each reference performance indicator; and
determining, according to the plurality of target performance indicators, the regression coefficient of each target performance indicator, the plurality of reference performance indicators and the regression coefficient of each reference performance indicator, an exchange relationship between the reference performance indicators and the target performance indicators, the exchange relationship being used for indicating whether the reference performance indicators are adjustable.

8. A terminal device, comprising: a processor and a memory; wherein
the memory stores computer-executable instructions; and
the processor executes the computer-executable instructions stored in the memory, so that the processor performs acts for processing performance indicators, the acts comprising:
acquiring historical business data comprising a value of a business indicator of an application program when a plurality of performance indicators have different values;
determining, according to the historical business data, a plurality of target performance indicators in the plurality of performance indicators and determining a regression coefficient of each target performance indicator, the regression coefficient being used for indicating an influence degree of the target performance indicator on the business indicator; and
determining, according to the regression coefficient of each target performance indicator and a minimum difference value of a significant change of the business indicator, a maximum acceptable deterioration value corresponding to each target performance indicator.

9. The device of claim 8, wherein determining, according to the historical business data, the plurality of target performance indicators in the plurality of performance indicators comprises:
determining, according to the historical business data, a plurality of performance indicators to be selected in the plurality of performance indicators, a problem of multicollinearity not existing in the plurality of performance indicators to be selected;
processing, by a multiple linear regression method, the plurality of performance indicators to be selected to acquire a P value of each performance indicator to be selected, the P value being used for indicating whether there is a significant difference between the regression coefficient of the performance indicator to be selected and a preset value; and
determining the performance indicator to be selected of which the P value is less than or equal to a preset threshold as the target performance indicator.

10. The device of claim 9, wherein determining, according to the historical business data, the plurality of performance indicators to be selected in the plurality of performance indicators comprises:
processing, by a lasso linear regression method, the historical business data to acquire an influence degree curve of each performance indicator on the business indicator;
sorting, according to a plurality of influence degree curves, the plurality of performance indicators in an order in which the influence degree becomes a preset value, and determining first N performance indicators in the sorted plurality of performance indicators as a plurality of initial performance indicators, N being an integer greater than 1; and
determining, according to relevancies between the plurality of initial performance indicators, the plurality of performance indicators to be selected in the plurality of initial performance indicators, relevancies between the plurality of performance indicators to be selected being less than a preset relevancy.

11. The device of claim 10, wherein determining, according to the relevancies between the plurality of initial performance indicators, the plurality of performance indicators to be selected in the plurality of initial performance indicators comprises:
determining the relevancy between every two initial performance indicators; and
performing, according to the relevancy between every two initial performance indicators, deduplication processing on the plurality of initial performance indicators to acquire the plurality of performance indicators to be selected; the deduplication processing being used for deleting one of two initial performance indicators between which the relevancy is greater than or equal to the preset relevancy.

12. The device of claim 8, wherein for any target performance indicator, determining, according to the regression coefficient of each target performance indicator and the minimum difference value of the significant change of the business indicator, the maximum acceptable deterioration value corresponding to each target performance indicator comprises:
determining a ratio of the minimum difference value to the regression coefficient of the target performance indicator; and
determining the ratio as the maximum acceptable deterioration value corresponding to the target performance indicator.

13. The device of claim 8, wherein before determining, according to the regression coefficient of each target performance indicator and the minimum difference value of the significant change of the business indicator, the maximum acceptable deterioration value corresponding to each target performance indicator, the acts further comprise:
determining a plurality of indicator values of the business indicator;
determining, according to the plurality of indicator values of the business indicator, an indicator average value and an indicator variance value corresponding to the business indicator; and
determining, according to the indicator average value and the indicator variance value corresponding to the business indicator, the minimum difference value of the significant change corresponding to the business indicator by means of T-test.

14. The device of claim 8, wherein the plurality of performance indicators are a plurality of indicators of the business indicator in a first business line direction; the acts further comprise:
determining a plurality of reference performance indicators of the business indicator in a second business line direction and a regression coefficient of each reference performance indicator; and
determining, according to the plurality of target performance indicators, the regression coefficient of each target performance indicator, the plurality of reference performance indicators and the regression coefficient of each reference performance indicator, an exchange relationship between the reference performance indicators and the target performance indicators, the exchange relationship being used for indicating whether the reference performance indicators are adjustable.

15. A non-transitory computer-readable storage medium, wherein computer-executable instructions are stored in the computer-readable storage medium, and a processor, when executing the computer-executable instructions, implements acts for processing performance indicators, the acts comprising:
acquiring historical business data comprising a value of a business indicator of an application program when a plurality of performance indicators have different values;
determining, according to the historical business data, a plurality of target performance indicators in the plurality of performance indicators and determining a regression coefficient of each target performance indicator, the regression coefficient being used for indicating an influence degree of the target performance indicator on the business indicator; and
determining, according to the regression coefficient of each target performance indicator and a minimum difference value of a significant change of the business indicator, a maximum acceptable deterioration value corresponding to each target performance indicator.

16. The medium of claim 15, wherein determining, according to the historical business data, the plurality of target performance indicators in the plurality of performance indicators comprises:
determining, according to the historical business data, a plurality of performance indicators to be selected in the plurality of performance indicators, a problem of multicollinearity not existing in the plurality of performance indicators to be selected;
processing, by a multiple linear regression method, the plurality of performance indicators to be selected to acquire a P value of each performance indicator to be selected, the P value being used for indicating whether there is a significant difference between the regression coefficient of the performance indicator to be selected and a preset value; and
determining the performance indicator to be selected of which the P value is less than or equal to a preset threshold as the target performance indicator.

17. The medium of claim 16, wherein determining, according to the historical business data, the plurality of performance indicators to be selected in the plurality of performance indicators comprises:
processing, by a lasso linear regression method, the historical business data to acquire an influence degree curve of each performance indicator on the business indicator;
sorting, according to a plurality of influence degree curves, the plurality of performance indicators in an order in which the influence degree becomes a preset value, and determining first N performance indicators in the sorted plurality of performance indicators as a plurality of initial performance indicators, N being an integer greater than 1; and
determining, according to relevancies between the plurality of initial performance indicators, the plurality of performance indicators to be selected in the plurality of initial performance indicators, relevancies between the plurality of performance indicators to be selected being less than a preset relevancy.

18. The medium of claim 17, wherein determining, according to the relevancies between the plurality of initial performance indicators, the plurality of performance indicators to be selected in the plurality of initial performance indicators comprises:
determining the relevancy between every two initial performance indicators; and
performing, according to the relevancy between every two initial performance indicators, deduplication processing on the plurality of initial performance indicators to acquire the plurality of performance indicators to be selected; the deduplication processing being used for deleting one of two initial performance indicators between which the relevancy is greater than or equal to the preset relevancy.

19. The medium of claim 15, wherein for any target performance indicator, determining, according to the regression coefficient of each target performance indicator and the minimum difference value of the significant change of the business indicator, the maximum acceptable deterioration value corresponding to each target performance indicator comprises:
determining a ratio of the minimum difference value to the regression coefficient of the target performance indicator; and
determining the ratio as the maximum acceptable deterioration value corresponding to the target performance indicator.

20. The medium of claim 15, wherein before determining, according to the regression coefficient of each target performance indicator and the minimum difference value of the significant change of the business indicator, the maximum acceptable deterioration value corresponding to each target performance indicator, the acts further comprise:
determining a plurality of indicator values of the business indicator;
determining, according to the plurality of indicator values of the business indicator, an indicator average value and an indicator variance value corresponding to the business indicator; and
determining, according to the indicator average value and the indicator variance value corresponding to the business indicator, the minimum difference value of the significant change corresponding to the business indicator by means of T-test.
